(19) United States
(12) Patent Application Publication
(10) Pub. No.: US 2006/0052095 A1
(43) Pub. Date: Mar. 9, 2006

(54) Communication method, system, devices and software arranged to operate in this system and devices

(76) Inventor: Behruz Vazvan, Helsinki (FI)

Correspondence Address: Sara VAZVAN, Suite # 173, 668 North Pacific Cost Hwy, Laguna Beach, CA, 92651, US

(21) Appl. No.: 11/264,331

(22) Filed: Oct. 25, 2005

(30) Foreign Application Priority Data
Apr. 30, 2004 (WO) PCT/FI04/00262
May 5, 2003 (FI) 20030670
Apr. 23, 2004 (FI) 20040571

(51) Int. Cl. H04Q 7/20

(52) U.S. Cl. 455/420; 455/445; 455/567; 455/556.1; 455/461; 455/419

(57) ABSTRACT

This invention provides a communication method, system, devices and software arranged to operate in said system and devices for communicating control and guidance information, or any messages and data information between different devices (1 or 2 or 5 or 6) like mobile or fixed devices such as telephone, mobile phones, wireless modules, computers, servers, a messaging centre, or any other device via a telecommunication network (e.g. GSM, UMTS, Fixed networks etc.), the method, system, devices and software according to this invention allows the transmitting of unlimited number of control or guidance information, messages, data etc. over a telephone call from a calling device (1) to a receiving device (2 or 5 or 6), said information represented by time values ranging from ringing times (the period of ringing) or length of call or a time value representing a piece of information like letter “A” to the number of ringing signals.

### BACKGROUND OF THE INVENTION

1. Field of the Invention

This invention relates to a communication method, system, arrangement, architecture, devices and software in this system and devices for communicating a plurality of control and guidance information, messages and data information between different devices (e.g. mobile or fixed devices such as telephone, mobile phones, wireless modules, computers, servers or any other device) via a telecommunication network (e.g. GSM, UMTS, Fixed networks etc.).

2. Description of the Related Art

In the existing digital communication systems for sending or receiving data or messages such as e-mail, SMS/WAP/MMS-messages (SMS: Short Message Services; WAP: Wireless Application Protocol MMS: Multimedia Messaging Services) the data is sent/received in form of bits (e.g. 001001, 1001001; presenting a fraction of data) between user terminals and network entities such as servers, portals, messaging centres etc. Therefore, for sending a message to another user or for activation a function in a remote device (such as “switching on sauna, adjusting temperatures or functions of a machine such as paper machinery or whatever device”) the actual message in form of data or a datagram message, a URL (Universal Resource Locator) or a code should be sent to the receiving device or a data communication path should be established between devices during which data is send and received.

A drawback of existing communication systems and services is that in different countries there are different network technologies. For example, a mobile telephone user in Europe using GSM standard (GSM: Global System for Mobile Communications) can send and receive short data messages (SMS/WAP/MMS) to other users having terminals using the same technology. Short messages can be also sent/received to or from user terminals via internet. However, if a European mobile user is roaming in a country where e.g. there is no SMS-service he/she can not send or receive any such messages. Therefore, in these cases, for data communications users are forced to establish end-to-end circuit switched data communications such as faxes or data calls which may cause them outstanding costs due to the long distance calls or expensive cellular network based calls etc. A user may not have also access to the internet via his/her fixed or mobile terminal simply due to the lack of support by the local network or his/her terminal.

Still another drawback of the existing communication systems and services is in using M2M services and applications. M2M is a term that represents a number of different types of communication: machine-to-machine, machine-to-man, man-to-machine, machine-to-mobile, and mobile-to-machine; it involves the process of giving machines, devices, appliances, and other assets the ability to share information with back office information systems and the people who use them. For example, in existing cellular network based M2M services e.g. applications and/or mobile users have to use data services such as SMS/WAP etc. in order to send and receive control and guidance information for activating functions for example in industrial applications, in home control systems (such as switching on sauna etc.). This may not always be possible due to the lack of support by users' terminals or network and also it may cause a lot of costs to users (for example users should pay the same price for sending SMS-messages one containing e.g. 100 characters but the other one containing only 5 characters). For example, for mobile commerce or for industrial applications user's terminal may send only a few character containing SMS message to an end device such as a server or a wireless module for purchasing e.g. a ring tone or for activating functions such as opening a valve etc. However, the user pays the same price of a SMS message containing 140 characters. This is not the case for telephone calls. For telephone calls users are in general charged per second which is a more justified solution. Moreover, even though few operators have recently offered their customers the possibility to send free but limited number of SMS messages per month but still the number of these SMS messages are limited and, however, users are billed for any SMS message they send when they are roaming in other networks e.g. abroad. Also the cost of such data services such as SMS/GPRS (General Packet Data Service) increases as more extensively users use the service. For example, an industrial company may need extensive messaging for its M2M applications. Moreover, in different countries there might be different network technologies and no data service such as SMS/GPRS might be available hence users can not have data access (e.g. via SMS/GPRS) to other locations (e.g. M2M applications) in other regions. Also the cost of such data communications increases when users want to access services in their home network while roaming in a visiting network abroad. Still another problem of existing M2M solutions using standard voice telephone calls is that in order to give instructions to a receiving device a call has to be placed over which user gives instructions. Even though in a solution, presented after filing date of the priority document of the present invention, a limited number of ring times are used for putting a receiving device to an answering mode, however, such solutions are based on the calling party's decision so that user is instructed, after dialling a telephone number, to listen the number of ring times (e.g. user should let ring twice) and then he/she must manually hang up the call and dial again the number in order to be able to give instructions over an established telephone call e.g. by pushing certain keys. Therefore, it is the calling person who has to make the decision to hang up the call before the receiving party answer the call. Also, a lot of mobile phone using teenagers, world wide, make every day millions of short calls to each other and hang up the call meaning e.g. “call me” etc. In all of aforementioned examples telephone calls are not pre-programmed in order to provide an automatic solution by which hundreds of applications and services could be provided to users when calls are made to one telephone number and without needing to answer the call.

Still another problem of existing communication systems, services and terminals is that in many user terminals such as e.g. Nokia mobile phones both the sending and receiving terminals contain the same pre-stored messages such as logos (e.g. a picture of heat, flowers, love messages etc.) that users can select and send to each others via SMS. Therefore, even though in the receiving terminal's memory or its SIN card (Subscriber Identity Module) there is the same message but user has to send from his/her own terminal the same message and pay for it if he/she wants that the receiving party receives such a message.

In existing telecommunication systems there are also services which are based on using DTMF-voice frequency signals. In these services the computer identifying the DTMF-voice frequency signals available through the telephone network i.e. the central voice applications platform (the CVAP) answers and the caller talks with the CVAP by pushing certain keys suggested by a predetermined program. By using DTMF-voice frequency signals no actual data, in form of text or graphical messages, is sent from the user terminal to the network but, however, said DTMF-voice frequency signals can be easily identified. A drawback of such services is that they are limited to a very limited number of DTMF-voice frequency signals so that not many commands can be given by user. On the other hand, the user has to push his/her terminal's keys during an established telephone call e.g. when listening to a voice instruction. Therefore, user has to pay in some cases, for example in telephone-based banking services, for a long telephone call.

There are also methods and systems such as voice-to-data and data-to-voice converters by which e.g. speech can be converted to form of data and be sent to another device via network. In these systems e.g. user has to talk the message that should be converted to form of data. The present invention provides a preferable solution with more advantages without needing to convert any speech/voice to form of data in order to be sent via a data call to another device.

Another drawback of many existing communication systems and services is the lack of security in communication due to viruses, hackers, unsecured messaging etc.

There are also several other drawbacks in existing communication systems and services that can be overcome by the present invention but for keeping this patent application reasonably short, the applicant avoids to mention all numerous drawbacks and leaves them to those skilled in the art in order to apply the present invention for any drawbacks and application that can be found or imagined.

Today, from one billion mobile users only half of them use services such as SMS/WAP etc. because many networks and devices has no such a feature neither many networks have any interoperability with other networks. Most of the services based on using the present invention, can be offered globally no matter is there any data service in the network the users are located or roaming.

On the other hand, lack of investment in developing countries has left them far behind the developed and rich countries in many fields including telecommunications and internet. While Europe, USA, Japan and other rich areas are moving toward more and more enhanced communication technologies such as 3G (third generation of mobile communications, in other words UMTS: Universal Mobile Telecommunication System), ADSL (Advanced Digital Subscriber Line), etc. many developing countries are stiff using analogue telephone services, or few of them may have also a first generation cellular network. Thanks to this invention: By using an embodiment of the present invention users of fixed and mobile terminals, using an application program of this invention, can send and receive data messages within a short normal telephone call, locally or globally. For example, regardless of is there any SMS/GPRS/WAP service in the network that users are roaming they can by using the present invention send short or long messages to each other locally, globally and very economically. Additionally, by using this invention e.g. mobile users can also browse web-pages, surf in Internet etc. globally and economically no matter if there is no existing data service available in the network they are roaming. Therefore, also a large amount of population of our world who are living in developing countries can enjoy from a data messaging solution which is considerably economical and cost-effective than building expensive communication networks that are not stilt even build up in many rich countries. Therefore, the present invention also promotes the development of our telecommunication world based on humanity values.

The present invention provides a solution to overcome all above-mentioned drawbacks and also drawbacks not mentioned here but which can be overcome by the present invention. Through this invention outstanding advantages can be achieved.

### BRIEF DESCRIPTION OF THE DRAWINGS

FIG. 1 illustrates one embodiment of this invention and illustrations of a series of displayed services via a device of this invention.

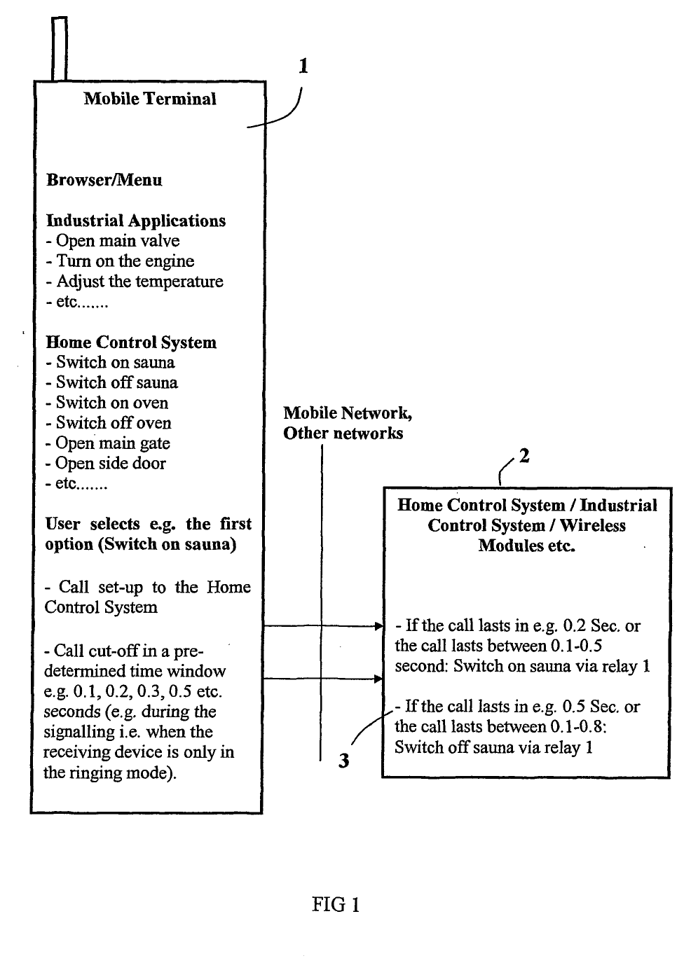

FIG. 2 illustrates one embodiment of this invention and illustrations of a series of displayed applications via a device of this invention that illustrate a second application of the principles of this invention.

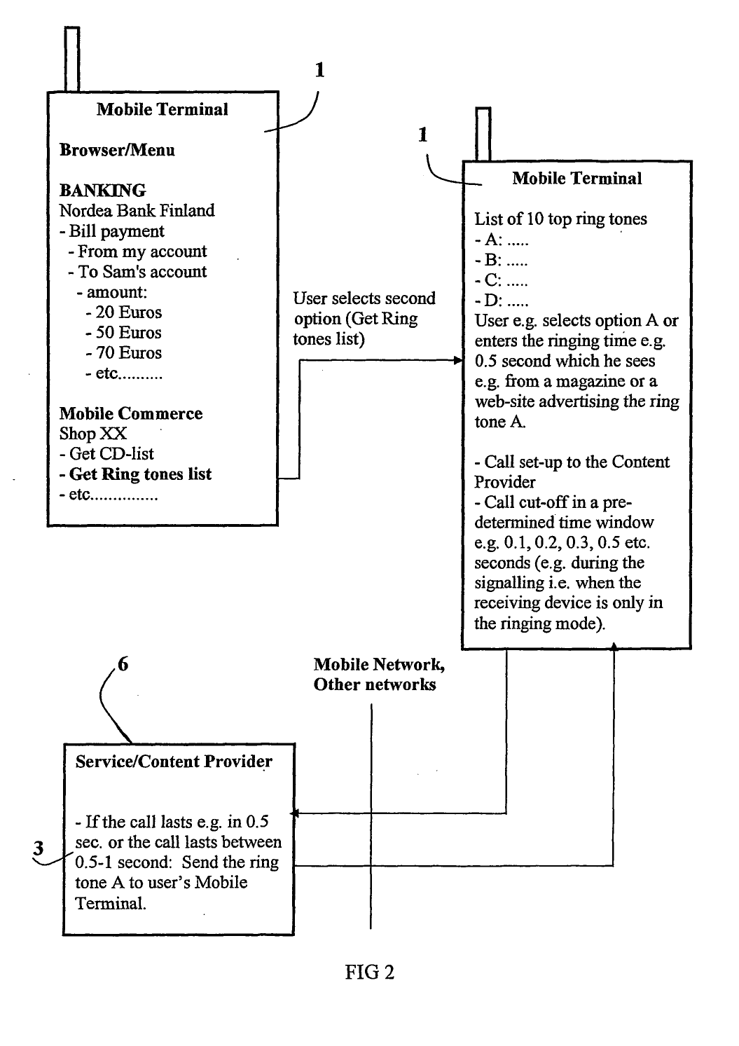

FIG. 3 illustrates one embodiment of this invention and illustrations of a series of displayed applications via a device of this invention that illustrate yet another application of the principles of this invention.

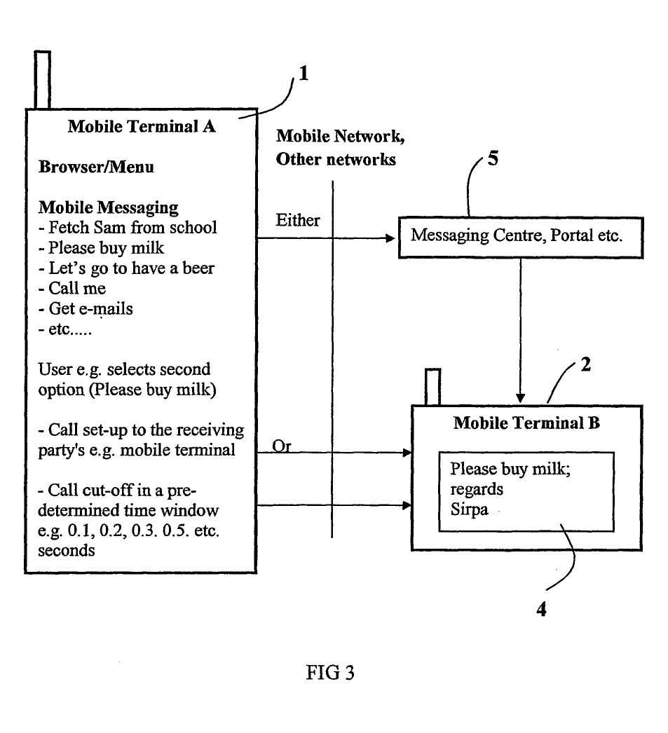

FIG. 4 illustrates a flowchart of a preferred embodiment of one of the methods of this invention.

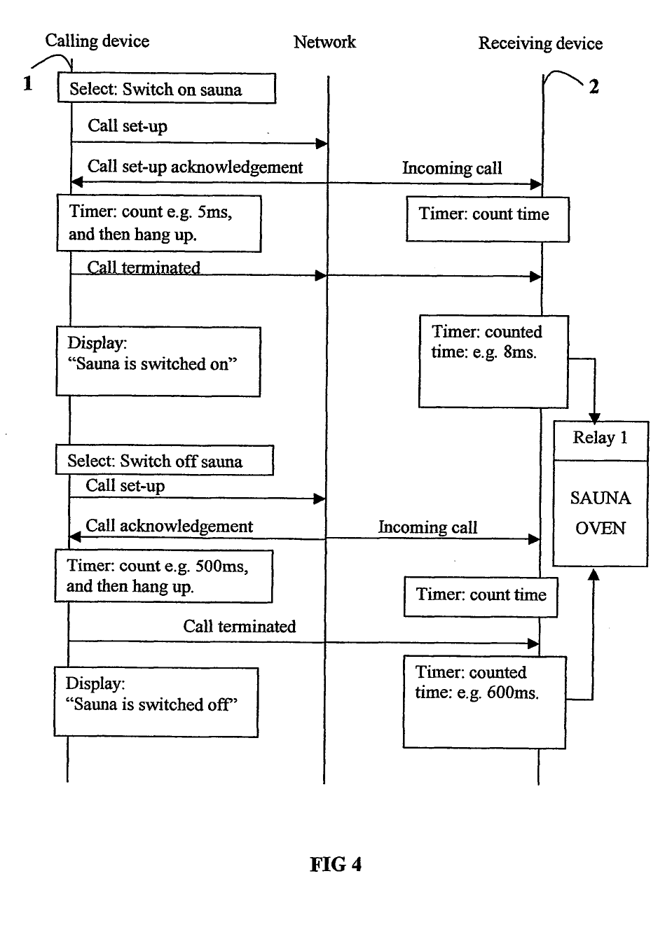

### DETAILED DESCRIPTION

According to one embodiment of the present invention a plurality of control and guidance information can be sent between different devices, for example between a mobile phone and an end device such as a wireless module, a server, a service provider or between any M2M applications, without needing to send any datagram message, SMS, URL etc. for activating a function, for sending or retrieving a message, for conducting a financial or commerce transaction etc.

According to another embodiment of the present invention a solution is provided that services which are already provided through existing communication systems (such as internet, SMS/WAP/MMS etc.) can be provided without needing to necessary send any data (such as SMS etc.) from the sending device, such as user's mobile terminal, computer or any telecommunication device, for messaging or activation of any function in or via a receiving device (which can be another user terminal, or a server, or a wireless module etc.). In this embodiment of this invention to one (receiving device's) telephone number hundreds of different control and guidance information can be given by user terminal for activation of hundreds of different functions (e.g. in industrial applications etc.) without needing to send said information from user terminal.

According to one embodiment of this invention the end device e.g. a server, a terminal, etc. 2 to which user terminal 1 sets up telephone calls, uses a program/application to activate a function per each call (e.g. “Switch on sauna” or display a message). The calling party number can be used to authenticate the calling party. Also other options can be used to identify users. To activate functions via or in receiving device 2 no telephone call is required to be necessary answered by receiving device but the service is carried out during the signaling i.e. when the receiving device is only in the ringing mode. According to the invention to one receiving number hundreds of telephone calls can be made but each one is addressed for a different function without needing to send any code, data (SMS, URL: Universal Resource Locator, etc.) related to that function. The predetermined value of ringing times 3 in receiving device 2 represent reference codes (e.g. such as URL) to any function or information in or via a receiving device 3. For example, a calling party may select each time an option in his/her terminal 1 (e.g. “Switch On sauna”, “Open main valve”, “Bring tools”, etc.) and each time a call is set up without sending any data to the receiving party 2. In a predetermined time window (ringing time) the call is hanged up in the calling device 1 without needing to be finally established (i.e. without need to be answered by e.g. a receiving party). In or via the receiving device 2 for each call a different function is carried out based on a predetermined ringing time 3. For example sauna is switched on, or a message is displayed to the user 4. Therefore, according to this embodiment of this invention no data (such as SMS, URL etc.) is sent from calling device 1 to the receiving device 2 but based on predetermined ringing times devices/users know what function/service (e.g. switching on sauna etc.) is in question. Subsequently, there are no extra costs for users except of monthly subscription fees (if available) for using their telephone subscriptions.

According to above-mentioned embodiment of this invention the application in a user terminal (for example cellular phone) 1 and an end device 2 such as another terminal or a computer, a switching centre, a network node, a server etc. is programmed so that when e.g. a user selects in his/her terminal 1 a command/link (such as “Switch on sauna”) the user terminal makes a telephone call to said end device. After that signalling is carried out between the user terminal, telephone network and the end device, without establishing a final call the calling device 1 terminates the call in a predetermined ringing time e.g. 0.2, 1, 2, etc. seconds. The end device 2 is programmed so that when it receives a call it starts to count time. For each period of ringing time a predetermined function can be carried out in or via said end device. After that the calling terminal 1 has terminated the call the end device 2 performs a function e.g. switches sauna on (via a relay) based on the ringing time counted in said end device. According to this embodiment of the present invention both in the calling terminal 1 and in the end device 2 for each function a predetermined time window or ringing time is programmed so that for each ringing time a certain function can be carried out. Depending on the operating system of calling and receiving device the ringing time in the calling terminal and the end device may rarely differ due to the delay (if any) caused by said operating system but, however, this delay can be taken into account. For example, when user of a calling terminal 1 selects or clicks in his/her terminal a command/link/message/name etc. such as “Switch on sauna” said terminal makes a telephone call to said end device 2 and terminates the call in a predetermined ringing time (e.g. 0.1, 0.5, 1 etc. second). When the call is terminated, in said receiving device 2 the ringing time is counted from the beginning of the call and the receiving device switches on sauna (e.g. via a relay) according to the predetermined ringing time (e.g. 0.1, 0.5, 1 etc. second) which can be the same or different as one predetermined in the calling terminal.

When user selects in his/her terminal 1 another command e.g. “Switch off sauna” said terminal makes a telephone call to said end device 2 and terminates the call in a predetermined time window or ringing time (e.g. 0.5, 0.7, 0.8 etc. second). Accordingly, in the end device 2 the ringing time is counted from the beginning of the call and the ringing time may be e.g. 0.5, 0.7, 0.8, or rather different or something between them. Therefore, this time the end device 2 knows that it has to switch sauna off. Therefore, said end device 2 switches sauna off e.g. via a certain switch, relay etc. The application in the calling terminal and end device is programmed for all predetermined time windows or ringing times so that said end device is defined to carry out a function based on a predetermined ringing time counted by said end device no matter what ringing time is used in said user terminal for hanging up the call (which in user terminal is based on what service/command/link user has selected e.g. “Switch on sauna” 1). In a same way unlimited number of applications can be carried out For example, user can open the gate or door of his/her house by his/her mobile phone, or he/she switch on/off lights or different machines etc. in a very secure manner only by making a short call without needing to send any information.

The calling and receiving parties can be identified e.g. by A-number or a predetermined ringing time (e.g. 0.4 second) or by other means. For example, for each user different ringing times can be allocated for each function he wants to be carried out in the receiving device. For example, when Sam selects from the menu of his mobile terminal 1 “Switch on sauna” his terminal calls to the home control system 2 and automatically hangs up the call in a predetermined ringing time e.g. 0.2 second. But when e.g. Sam's father Behruz wants to switch on the sauna her terminal calls for 1 second and then hangs up the call. In the home control system 2 the application program counts time for different ringing times i.e. the zinging time of calls placed by Sam and Behruz. For example for Sam in the home control system 2 it is already defined that if a phone call lasts in 0.5 seconds it is Sam and he wants to switch on sauna. Whereas if the call lasts e.g. in 1.5 second then Behruz is in question and he wants to switch on sauna. If sauna is already switched on or there is a problem etc. the caller may receive from said home control system 1 a telephone call (according to the invention) or receive a message (e.g. SMS) indicating that sauna is switched on or there is a problem etc. Therefore, in this invention users can be identified also by ringing time of telephone calls they make to an end device. These ringing times can be updated time to time or at any given time for more security. Therefore, the system is completely secure also because no data is sent from calling terminal to the receiving device. This can be one of the best applications also for services requiring high security levels such as electronic banking and commerce etc. On the other hand in some applications (for example for home control systems) if the phone number of receiving device 2 is completely secret and known only by one or a number of users who have right to make telephone calls to such a number then users do not necessarily need to be even identified. For example, in a home control system the members of the family have right to switch on/off sauna and they have saved the number of home control system 2 in their mobile terminal or its smart card etc. Moreover, the services wherein this invention is used can be also more secured by a PIN-code asked by user terminal whenever he/she wants to use the services.

There might be thousand of messages such as “let's go to dance”, “please by milk, “bring tools”, etc. which users send to each other redundantly, every day, every now and then. For example, a worker in a construction field may need some materials or tools. According to this invention he/she can e.g. select/click in his/her mobile terminal's menu/browser 1 “We need screws”. Said mobile terminal then makes a phone call to his/her supervisor terminal 2 or the telephone center 5 of the company wherein same messages (such as “We need screws”) are beforehand stored and linked to e.g. different ringing times. After that calling terminal receives a signal indicating about an outgoing call to said receiving device the call is hanged up by calling terminal 1 in a predetermined ringing time without needing to establish a final telephone call (i.e. the receiving party does not need to answer the call). Also when receiving terminal receives a signal about incoming call it starts to count time. Therefore, after hanging up the call by calling terminal the supervisor's terminal or the company's telephone center (or computers linked to it) count the period of ringing time and based on a predetermined ringing time said message (which is also pre-stored there) is retrieved from the memories of said terminal or computer and displayed or informed to the person who is concerned. Therefore, the worker can inform his/her supervisor about what he/she needs without sending any actual data message (such as SMS etc.) to said supervisor or said company and without establishing a final call hence said message (which is not actually and physically transmitted) is transmitted or identified by ringing times (and also free of charge). The receiving device 2, 5 (e.g. supervisor's terminal or its smart card, or company's computer) according to one embodiment of the present invention is programmed so that when a telephone call, as mentioned above, is received the message (“We need screws”) which is retrieved from said supervisor's terminal or from said company's computer is again stored, with the information related to the calling party (e.g. A-number, name etc.), but this time in a list of incoming/inbox messages so that in point of view of receiving party (e.g. supervisor) said message (“We need screws”) looks like an actual message that could be imagined to sent by said calling party (worker) e.g. via SMS, e-mail etc. Therefore, the follow-up of receiving messages is handled for user (said supervisor) in a user-friendly way and said messages can be answered by a reply call using the present invention, or by using e.g. SMS etc. if available. According to the present invention the application program used in receiving party's terminal 2 is programmed so that after that each call is hanged up, as mentioned above, said terminal informs his user about a received message (e.g. by an voice alert etc.) e.g. in a same way as existing mobile phones inform their users about received SMS messages. Then e.g. user of said receiving terminal 2 can e.g. by accepting an option (such as “Show the message”) retrieve said message from said terminal's memory whereupon said message can e.g. be displayed 4 to user. Furthermore, in the calling terminal 1 depending on the user selections e.g. from a menu/browser of his/her terminal the application program according to the present invention can put the outgoing calls in a right order. For example, if user selects/clicks one after other e.g. following commands “Switch on main pump”, “Switch on cleaning pump”, “Open main valve”, etc. his/her terminal puts telephone calls related to these control commands in a queue and makes for each command a telephone call according to the selection order or an order already defined by user or e.g. industrial application etc.

According to another embodiment of the present invention said predetermined ringing times or call times are stored in a computer, server etc. (such as a call centre, an internet portal, a messaging centre, a company's computer, user's own PC etc.) 5 which can operate as a messaging centre so that based on incoming calls, each allocated for a predetermined function, message etc. said messaging centre 5 can forward a message (that the calling party has meant, and it is defined by a counted ringing time in said messaging centre) to a receiving party. The receiving and calling parties can be identified in many ways. In one option, for example, the calling party can be identified by his/her A-number. In another option the receiving party and calling parties can be identified by predetermined time values (e.g. ringing time). In another option the receiving party can be identified by his phone number dialed by calling party after e.g. a prefix or sub-number of said messaging centre (for example the messaging centre number can be 010203 and the receiving party's number may be 050 491 8286). Such arrangement of numbering and checking of such a numbers in said messaging/switching centre is an easy arrangement for those skilled in the art and well known e.g. in intelligent networks (IN). Therefore, for keeping this patent application reasonably short, the inventor does not explain all techniques related to such arrangement. In this option said message centre 5 is arranged so that after receiving a calling party's telephone call and hanging up the call (by said calling party's terminal 1) said messaging centre sends the message, what calling party wished, to a receiving party's e.g. mobile terminal 2 (or said centre makes a telephone call to said receiving party and hangs up the call in a predetermined ringing time whereupon a function is carried out in receiving device e.g. a message is retrieved from the memory of receiving device and displayed to its user 4). Said message 4 can be identified and retrieved from a memory means of said messaging centre 5, or memory means connected to it, based on said predetermined ringing time. Also the applications for this embodiment of the present invention are unlimited. For example, said messaging centre 5 can be an electronic image/picture/post card etc. bank or center operated by a service provider. A user may e.g. see the images/pictures advertised by said service provider via different media (e.g. newspapers, internet etc.). For each image/picture a ringing time is allocated by said service provider. For example, in said advertisement the identification code of an image may be represented by number 2 which actually means 2 milliseconds of a ringing time to said messaging centre by a calling party. Therefore, when a calling party e.g. enters said value (i.e. 2) into his/her terminal 1 (using the application program according to this invention) and dials said messaging centre 5 number and the number of receiving party, his/her terminal makes a telephone call to said messaging centre 5 and hangs up the call after 2 milliseconds. In said messaging centre 5 based on a predetermined ringing time said image/post card etc. is retrieved from a certain memory and send to the receiving party's e.g. mobile terminal, or e-mail system, or via traditional mail. Also in cases the receiving party's terminal is switched off said messaging centre can forward the message of calling party later on. Also by using this embodiment of this invention a calling party can send to a receiving party, a friend etc. messages, post cards etc. without needing to send said message from his/her own terminal and without need to have a data service (e.g. SMS etc.) at the network side he/she is connected.

In above-mentioned example instead of taking into account only ringing times a call can be completely established between the user terminal and end device. However, the time window for any control and guidance information can be counted from the beginning of the call (e.g. when the ringing signal is observed by each device) or after that the call is finally established (i.e. the receiving device answers the call). On the other hand the number of ringing signals, observed by each device via the network, can be used e.g. for transmitting control and guidance information. Alternatively, a combination of above-mentioned options can be used for implementing the invention. All these options can be used for different services and different embodiments of the invention.

In another embodiment of the present invention the value of time windows or ringing times can be given/entered by the user of calling terminal 1 to his/her terminal. Also in this example the end device is programmed for all predetermined time windows, ringing times so that each ringing time is predetermined for a certain function/command etc. Also this embodiment of the present invention can be used for different services. For example, in mobile commerce, for purchasing a ring tone the service provider 6 (i.e. ring tone seller) can use different predetermined ringing times for different ring tones, logos, images, messages etc. and distribute an advertisement of said ring tones, logos etc. with predetermined time values (e.g. 1, 2, 3, 4, etc. millisecond) for identifying any ring tone, logo etc. via its web-site, newspapers or any other media Therefore, the calling party by entering the value of a certain ringing time into his/her mobile terminal 1 (e.g. a GSM phone) and calling to said service provider's end device 6 (e.g. a switching centre, computer, server, internet portal etc.) can purchase a certain ring tone, logo, image etc. and receive it e.g. via SMS/MMS etc. to his/her or another mobile terminal. Therefore, by using the present invention in such a services users can save at least 50% of their communication costs since they don't have to send a SMS-message or establish a final call for purchasing a product (such as ring tone). The ring tone seller should pay to the mobile operator only for sending a SMS-message (including the ring tone). The user pays for the content (i.e. the ring tone). Therefore, in this way much more cost-effective services can be provided to end users; thanks to this invention. This in turn adds the whole sale of service and content providers because more people are able or willing to buy services which are more cost-effective. Therefore, the traffic, from the service or content provider side, increases also to the benefit of mobile operators i.e. more revenue for operators (i.e. a higher ARPU: Average Revenue per User i.e. per content providers). For purchased ring tones users can be charged in different ways: for example via their telephone bill, an electronic bill a pre-paid account, a traditional bill etc. Users pay for their short telephone calls (which are not actually and finally made) by paying their monthly subscription fees (if any). For example, in Europe if user has a telephone subscription (such as mobile subscription) he/she can receive any telephone call only by paying his/her monthly subscription fee i.e. payment of a monthly subscription fee allows him/her to receive even millions of calls per month. Pre-paid subscribers do not pay even a monthly fee. Therefore, the users who makes short but not final telephone calls (i.e. the call is not finally established but it is hanged up before the calling party answer the call) should not pay for any such a telephone calls because they are actually paying a monthly fee for using their subscription and in such telephone calls they are not sending any data (such as SMS etc.). However, if needed users can be also charged for such telephone calls but the charges would be a very small fraction of their communication costs since as mentioned above users do not use the network for sending any data (such as SMS, Circuit Switched Data Service, Packet Data Services etc.) hence the network capacity is available to data communication services. In many countries mobile operators offer their customers even many hours of free talk per week etc. only in order to keep their customers with them or to attract more new customers, Also, a lot of mobile phone using teenagers, world wide, make every day millions of short calls to each other and hang up the call meaning e.g. “call me” etc. Therefore, the purpose of the present invention is not to cannibalize the existing services (such as SMS etc.) but to provide an inventive solution that enables operators gain more traffic from the service and content providers sides, or operators can save radio capacity for other purposes. Service and content providers will be able to offer much more cost-effective services hence promoting their sale. By offering services based on the present invention operators can attract more customers. In many cases, the services based on using the present invention, can be offered globally no matter is there any data service in the network the users are roaming.

In another embodiment of the present invention said predetermined time windows or ringing times can be used for retrieving information such as e-mails, news, etc. For example the calling terminal 1 may make a call to a predetermined e-mail system 5, 6 (for example Microsoft's Hotmail system) for retrieving e-mails. The user can be identified in said e-mail system e.g. by user A-number or by a predetermined ringing time or by other options. Then the e-mail system can send to user terminal (e.g. via SMS/MMS etc.) a list of headers of new e-mails arrived to the user's mail box. Each row of said list can be predetermined by a certain ringing time in said e-mail system prior to sending said list to the user terminal 1. When user selects a command e.g. “e-mail from Sam” (or according to the subject of message etc.) his/her terminal 1 makes a telephone call to said e-mail system and terminates the call according to a predetermined ringing time already defined by said e-mail system. In the e-mail system the application according to the present invention is programmed so that based on certain predetermined ringing times any certain message can be retrieved from the e-mail box of the user and sent to the user e.g. in a SMS message.

According to another embodiment of the present invention both the user terminal 1 and said end device 2, 5, 6 can make telephone calls to each other and terminate the calls according to the invention in predetermined time windows or ringing times in order to carry out messaging or to transmit control and guidance information. For example, many of messages (SMS etc.) that users send to each other may be redundant messages. For example, while you are in move, your wife may call or send you messages every now and then and asks e.g. “Please buy milk” etc. A friend may every now and then send you a message e.g. “Lets go to have a bear” etc. Such messages can be pre-stored in users' terminals' or their smart cards' (such as SIM-card) memories and can be updated whenever required e.g. via a web-site, via a service provider or by users themselves. When a calling party selects from the menu/browser/memory of his/her terminal 1 e.g. a command such as “Please buy milk” which is pre-stored for a certain user (or users) said terminal makes a telephone call to the receiving terminal or end device 2 and terminates the call in a predetermined ringing time. In said receiving terminal 2 the ringing time is counted as explained in previous examples. According to a certain predetermined ringing time the receiving terminal 2 retrieves or generates a message e.g. “Please buy mill, regards Tina” 4 from the terminal's or its smart card's memory and displays 4 it to its user together with information about calling party (e.g. based on A-number etc.). In this example if users' terminals are their mobile phones then the application, for such terminals, according to one embodiment of the present invention is programmed so that in case of an incoming call the receiving party's terminal does not ring for a period of time e.g. 1 or 2 second etc. Since the call can be already terminated within said 1-2 second (e.g. in 0.1, 0.2, 0.5, etc. second). Then based on a predetermined ringing time said receiving terminal retrieves said predetermined message (e.g. “Please buy milk, regards Tina”) from its memory and displays 4 it to user e.g. in a same manner as SMS/MMS etc. or via a browser. On the other hand since said predetermined messages (e.g. “Please buy milk” etc.) can be pre-stored in both calling and receiving terminals' or their smart cards' memories or other memory means with the user data (e.g. A-number) if any other party accidentally makes a short call to said user said receiving party's terminal does not display any predetermined message. Moreover, according to the invention, the predetermined menus (including e.g. “Please buy milk”, “Lets go to have bear”, etc.) can be pre-stored in a menu/browser. Therefore, the calling party may not even accidentally make a telephone call to the receiving party since he/she has to first select a menu via which selects a message required. Furthermore, for more security, such menus can be accessed via a personal code (PIN-code).

According to the present invention the value of ringing time, time windows or periods which are predetermined for any action or messaging can be whenever required updated and changed. Depending on the application, this action can be done e.g. by a service provider such as a bank etc. for more security of communication. Updating of said time values can be also carried out by applications themselves e.g. after each telephone call (when an application is used). Therefore, both the calling device and receiving device can substantially in real-time (e.g. after each call) perform an update of said time values. The updating algorithm can be used in applications using this invention. Therefore, said time values are also after updating in a range that the service can be carried out as before. For example, suppose that for switching on sauna, a ringing time value of 0.1 second time is used in the calling device for terminating the call while a ringing time value of 0.1 or 0.5 second is used in the end device (e.g. a wireless module) for switching on sauna (via a relay). After updating said time values they may be e.g. 0.3 second for calling terminal and 1 second for receiving terminal. Both devices can confirm said updating e.g. by establishing a telephone call or sending a message to each other, otherwise e.g. said values can be remained unchanged. This option is for more security. Said time values can also be updated by a service or application provider e.g. by a telephone call or OTA (in case of wireless devices) to all devices concerned (OTA: Over the Air Activation). Depending on the application, said time values can also be given manually (e.g. by users). For example, in an industrial application, the service maintenance employee may enter said values, according to a scheme, for an application. The new values then can be send e.g. via a telephone call (according to the invention) or by a message (e.g. SMS etc.) to the concerned devices. Different ways can be used for updating said time values. Therefore, the invention is not limited to above-mentioned example.

The invention provides also great advantages for any service requiring high security but in a fast way without necessarily needing to involve encryption methods for sending information from user terminal. For example, in medical services ordering of medicines can be carried out by only making a telephone call to a service provider such as pharmacy and then said call can be terminated in said predetermined times each allocated for a specific medicine.

According to another embodiment of the present invention any message can be written or selected, read etc. and be sent and received between users 1, 2 using an electronic communication device according to the present invention e.g. such as mobile terminal, fixed telephone device, etc. only by using a short normal telephone call (i.e. not a data call) and without needing to send any datagram or SMS-messages and without needing to pay for expensive telephone calls (e.g. long calls). In this embodiment of the present invention there is no necessarily need to have a data service such as SMS/WAP etc. at the network side or support of such services in the user terminal 1 but, however, users can send and receive SMS-like short messages and if needed long messages, e-mails etc. Also, there is no need to have necessarily a user data communication device (i.e. a device that is enabled for communicating data ranged from fixed/mobile data services to wireless data services). In this embodiment of the present invention in user terminal (e.g. mobile phone) an application is used that is programmed so that for each piece of information (e.g. a character A, B etc.) a time value is predetermined so that when e.g. a letter (e.g. A or b) is selected via a keyboard or keypad etc. of said user terminal 1 the program determines or gives said letter a predetermined value of time (e.g. 1-2 millisecond) having a starting value (e.g. 1 millisecond) and an ending value (e.g. 2 millisecond), or only one value (e.g. 1 millisecond) for the whole letter. Therefore, according to this embodiment of the present invention each character or letter or symbol etc. is given a time value by which said character can be identified and displayed to a receiving party (via his/her terminal 2) when said character is sent, in form of time value, from calling terminal 1 to the receiving terminal 2. According to the present invention transmitting and receiving of said time value can be carried out within a normal voice telephone call, for example, as follows:
typing or selecting the letter (e.g. a, b, etc.) in the calling terminal 1;
giving said letter a time value (e.g. 1 millisecond);
storing said time value in form of sound/voice (i.e. for one millisecond a sound/voice is stored that represents said letter “a”). Said voice can, for example, be produced by a key function of said terminal's keypad/keyboard etc. or by any other known means;
In said calling terminal, making a telephone call to a receiving terminal 2 (e.g. a mobile phone);
answering said call by receiving terminal 2;
In said calling terminal 1, playing said sound/voice (representing said letter e.g. “a”) having 1 millisecond time value (i.e. length of playing) whereupon when said sound/voice received by said receiving terminal 2 said receiving terminal identifies/notices/recognizes/observes the length of said sound/voice;
At this point, optionally, hanging up the call or if desired continuing the call (depending on the application);
In said receiving terminal 2, storing said time values (i.e. length of each played sound/voice representing a letter e.g. “a”) in a memory;
In said receiving terminal 2, based on said time value (1 millisecond) producing/storing said letter (e.g. a, b, etc.) or the whole messages in its original form as the sender has typed/selected, and whenever required displaying 4 it to user of receiving terminal.

Therefore, in this embodiment of the present invention information is represented by time values in form of sound or voice signals, sent to the receiving terminal 2 over a normal voice telephone call, said time values are then translated to information (e.g. letters, a, b, c, etc.) and displayed 4 to user via a screen of user terminal. The above-mentioned example can be also used in all analogue-to-analogue, analogue-to-digital, digital-to-analogue, digital-to-digital etc. telephone calls, wherein e.g. there is no central voice applications platform (the CVAP) enabling the use of DTMF. Moreover, CVAP-based services are very slow for such services. The telephone call in above-mentioned example can be terminated e.g. in a second after that said calling terminal 1 has played/released said sound/voice signals over the call. For transmission of words or long text etc. messages the same method can be used but for identifying letters from each other a delay (e.g. 1 millisecond silence) can be used between the sounds/voices allocated for different letters “a, b, c, etc.”. For shaping the whole message another delays (e.g. 2 milliseconds) can be used between words etc. In the calling terminal 1 the message can be displayed to user as he/she is typing it. When user has typed the whole message then he/she can use a button e.g. “Send” of his/her terminal in order to send the message to a receiving party. Then his/her terminal selects a predetermined time value for each piece of information (e.g. characters “a, b”, etc.) as a length of a voice/sound signal to be played over a telephone call. User terminal makes a telephone call to the receiving device 2 whereupon said message is played in form of sound/voice to the receiving device in few milliseconds. The receiving terminal selects for each sound/voice signal a corresponding bit of data (e.g. characters a, b, etc.) according to the predetermined time values and puts the whole received message e.g. in a readable order that can be displayed to user as the original message typed by the sender. After that said message is received by receiving device 2, the calling terminal 1 or receiving device can terminate the call. For example the message “I LOVE YOU” can be translated to time values as follows:

I=1 millisecond, Empty space=2 millisecond,

L=3 millisecond, Empty space=1 millisecond

O=4 millisecond, Empty space=1 millisecond,

V=5 millisecond, Empty space=1 millisecond

E=6 millisecond, Empty space=2 millisecond,

Y=7 millisecond, Empty space=1 millisecond

O=4 millisecond, Empty space=1 millisecond,

U=8 millisecond.

Therefore, according to above example the transmission of said message “I LOVE YOU” takes only 47 milliseconds (i.e. 0.047 second). Of course, many of the above mentioned time values can be even smaller. For example instead of 1 millisecond a 0.1 millisecond value can be used, and accordingly instead of 2 milliseconds a 1 millisecond (or less etc.) value can be used. Therefore, a long message can be sent in few milliseconds. Said time values and empty spaces (i.e. delays) can be set in a range that when they are arranged one after each other and are, at once, played by the calling terminal during the telephone call and when received by receiving terminal it would be able to recognize their values (i.e. the length of each played sound/voice). For this purpose, if the time values are very short (e.g. 0.1 millisecond or less), the program application in the receiving terminal can stretch the length of voice message by a predetermined factor in order to better recognize different time values (presented by sound/voice signals) each representing a letter, a delay, a symbol etc. Said predetermined factor can be used in both calling 1 and receiving terminal 2. In a simple example, this function can be compared to known voice recording methods by which one can record his/her voice or a piece of music in a low speed and play it in a higher speed resulting in original voice. In many different ways the sending voices/sounds can be compressed in calling terminal, sent to the receiving terminal where they can be decompressed. Therefore, for keeping the description of this application reasonably short the applicant leaves to those skilled in the art to use any proper technology required to implement this function (i.e. recording and stretching the length of voice messages by a predetermined factor). All symbols, digits, alphabets, etc. can be represented by a time value. By using this embodiment of the present invention users of fixed and mobile terminals, using the application program according to this embodiment of this invention can send and receive data messages in form of time values (presented by sound/voice signals) within a normal telephone call locally or globally. The present invention can be used also in data terminal such as fax machines etc. without needing to use fax standards and protocols, but the data can be sent in voice/sound signals determined by said time values over a normal telephone call. In this case the data of a fax to be transmitted is first translated in sending terminal to said voice/sound signals representing each part of data in said time values. The data is then saved in the memory of terminal, a call is placed, the voice/sound signals are released/played over the call for receiving device, and the call is terminated by sending or receiving device. In the receiving device the signals are processed as mentioned above. The application program of this embodiment of the present invention can be stored in said devices or can be downloaded. Said program can be stored or downloaded to users' SIM or other smart cards or memory cards/chips used in connection with user terminal such as mobile phone and be used right a way. Also the information about time values representing data can be sent to receiving terminal along with the message to be sent or separately whenever required. Furthermore, the messages can whenever required be encrypted/decrypted using a known encryption algorithm. To display messages any browser or existing solutions can be used. For example, according to the invention, for short or long messages received over a normal call in a user mobile telephone, messages can be stored, retrieved, displayed etc. in a same way as normal SMS messages are handled in existing mobile terminals.

By using this invention users can also browse web-pages, surf in Internet etc. globally and economically no matter is there a data service available in the network they are roaming. For example, by using this invention, when user makes a short telephone call to a service provider (such as a bank) end device e.g. a server, said user can retrieve and browse the web-page of said bank within a short time and a normal voice telephone call without needing to use modems, data cards etc. For browsing another page, e.g. by clicking a link, user terminal makes another call, to the same number (service provider) and hangs up the call e.g. in 5 millisecond which is predetermined by service provider for retrieving the page related to said link. Actually, said service provider can allocate different ringing times for all links included in the page that has to be sent to user terminal. Therefore, when user terminal retrieves a page said page has the information about ringing time allocated for each link. When user selects a link his/her terminal makes a short telephone call to said service provider and hangs up the call in a predetermined ringing time already defined by the computer system of said service provider. According to the invention, allocation of different ringing times for different URLs is a fully automatic and fast action carried in said service provider's server (and when required by a network node) which can be carried out per each user telephone call. As an other example, when user terminal makes a call to a service provider in order to retrieve the web-page of a search engine such as Google said terminal retrieves the Goolge's web-page in a short time and then can hang up the call. For searching, user may enter in the search box of Google a word (e.g. “Electronic post cards”). Then by pushing e.g. a “Send” or “Enter” etc. button of his/her terminal user makes a normal telephone call to his/her service provider. Then his/her terminal sends said word in form of sound/voice signals having predetermined time values. In the service provider's servers said word (“Electronic post cards”) is automatically entered in search box of Google (unless said service provider is itself Google) and the information received by said service provider from Google can be send in form of time values to said user terminal and then the call can be hang up. For continuing the search etc. user terminal makes another call according to this invention. Since most of the calls are not established finally (i.e. are not answered by receiving device) they are free of charge. Only the phone calls during which the information is transmitted (e.g. in form of time values) may not be free. Of course, by using this invention the above-mentioned example can be carried out in different ways. Therefore, the invention is not limited to the above examples.

In all above-mentioned embodiments of the present invention, and other embodiments that can be imagined, different technologies can be used to implement this invention. For example, as mentioned above, the application program according to the present invention can be stored or downloaded to the user terminal or end devices' memories or attachable/detachable memory cards, or smart cards (such as SIM cards. SIM: Subscriber Identity Module). For example, for mobile terminals (such as GSM phones) using SIM cards having SIM-toolkit features said application program can be stored/downloaded and used via SIM card. For example, for user terminal the application program according to the present invention can be displayed in form of a menu/browser or any other suitable and user-friendly form for implementing and using thousands of different applications. For new terminals (such as GSM terminals e.g. Nokia's, Siemens's etc. terminals) using SIM-toolkit, Symbian, Windows, or Linux etc. operating system said application program can be stored/downloaded to said terminal, user's SIM card, or to terminal's attachable/detachable memory cards and be used in any generation of cellular networks to which said terminal can have radio access and make normal telephone calls, but without needing to necessarily have a data service at the network side because the present invention can be used over the normal telephone calls.

The present invention can be used for different services such as electronic commerce, banking and A) financial, etc. services. For example, a party (e.g. a bank, a shop etc.) can send a bill in a message (text or graphic) to the payer's terminal via SMS/internet etc. or by using the present invention. Said message may include the information about the ringing time related to each option for paying said bill. For example, user terminal can display said bill to said payer and gives him two options “I accept”, I don't accept”. If user selects the option “I accept” then his terminal can extract the ringing time information (and if required the phone number) from said message and makes a telephone call to the message sender (e.g. a bank) and hangs up the call according to said predetermined ringing time. In the computer system of said bank the call and guidance command (“I accept”) can be identified based on said predetermined ringing time and the bill can be paid.

Alternatively, in the present invention instead of said predetermined ringing times, the number of ringing signals of incoming and/or outgoing calls can be used for several services. In this invention the ringing time means the period (e.g. 5 seconds) within which the receiving device should ring before the call is answered. In this invention the length of call means the time counted from the beginning of ringing or from the beginning of an established call until the call at a predetermined time is terminated. In this invention the ringing signals (ring times) mean the number of signals (e.g. sound signals) that a receiving device or calling terminal identifies/detects/observes when a call has been placed to a receiving device but before the receiving device answers the call. For example, for switching sauna on/off different number of ringing signals can be used in calling or receiving terminals. For example, when user selects “Switch on sauna” from the menu of his/her terminal said terminal may make a telephone call to a device (such as wireless module) at home and hangs up the call after said terminal observes/receives from the network e.g. two ringing signals related to the outgoing call. However, in the receiving device at home (such as wireless module, computer etc.), during the call signalling, said device may receive from network 2-3 ringing signals. Regardless of how many ringing signals the receiving device may receive a certain number of predetermined ring times (e.g. 2, 3, 4 or a value between them e.g. 3) or a predetermined ringing time can be used for switching on/off sauna. Said hanging up of the telephone call happens automatically by said predetermined values and without needing the caller to decide when the call should be hanged up.

Alternatively, in the present invention said predetermined ringing times or ringing signals can be used just for making calls by users' terminals but any other communication means and messaging such as internet (WAP/SMS etc. if available) can be used for sending the information from other devices (e.g. a server, other party's terminal etc.) to said user terminal. Alternatively, the present invention can be used to send said information to users' terminal no matter is there any data service available at the network the user is roaming or the sender is located because according to the present invention the data can be transmitted over a normal voice telephone call as mentioned above. In above-mentioned examples if a receiving terminal (such as mobile phone) is turned off and the call is forwarded to an answering system the calling device, after detecting that a voice is responding, can immediately terminate the call and display a message to the calling party that e.g.: “the receiving device can not be accessed, try later”. Alternatively, said answering system can be programmed with the application of the present invention so that when the call is forwarded to it the calling device e.g. after listening the voice message of said answering system counts time and hangs up the call in accordance with a predetermined length of call whereupon said answering system knows that what task should be performed (e.g. selecting and sending a message to said receiving device later). Alternatively, if user of calling terminal is sending e.g. a text message using the present invention (i.e. in form of time values played by voice or sound signals over the call) said text message can be received by said answering system, stored and forwarded later to said receiving device. Additionally, in all above-mentioned embodiments of the present invention a data-capable terminal and a data call (a normal data call or e.g. VOIP: Voice Over Internet Protocol, etc.) can be also used to implement the invention but, however, no control and guidance information or other data messages is needed to be sent from the calling terminal to the receiving device but according to the invention said predetermined time values: ringing times, or the number of ringing signals (ring times), or the length of calls define what control or guidance commands are in question. Since no information, related to the applications accessible or performable via said receiving device, is needed to be sent from the calling terminal the system is very secure for any application e.g. banking etc. Also messages can be sent from a calling device over a data call (or VOIP etc.) but according to the invention messages are in form of time values (e.g. 1 millisecond, 2 millisecond etc. as explained above) that are played/released in form of voice/sound over a communication path for the receiving device. However, one of the most important advantages of the present invention is that it can be used over a normal standard voice call wherever and globally no matter is there any data service available or not.

According to this invention the menu/browser/application in the user terminal (such as mobile terminal, computer etc.) or its smart card (such as SIM etc.) or other attachable memory means, incorporating the features of the present invention, can be sent or downloaded to the user terminal. This can be done both either by the user via e.g. internet, via his terminal or by a service provider, e.g. a bank, etc. Said menu can be updated whenever required.

To prove that the technology of the present invention is feasible, the inventor conducted a concept study of the technology according to one preferable embodiment of the present invention. For the study a Symbian OS (Operating System) program was created which allowed specifying wanted ringing time, for the caller end, and which counted the ringing time in the ringing end. Test was conducted by making phone calls between two Symbian OS phones, namely Nokia 3650 and Nokia 7650. The conclusion of the study was that the present invention is completely feasible and applicable for any application. In order to refer to an example of an application of the present invention applicant- refers to a copyright document filed with the priority document of the present application in National Board of Patents and Registration of Finland.

The applications of the present invention are unlimited. The services based on the present invention can be offered globally where ever there is a communication system via which telephone calls can be made or received. The software and application programs of this invention can be stored or downloaded and operated as much as required in a calling device or a receiving device or in both of them depending on the applications. For example, in an embodiment of this invention the software according to this invention can be used both in the calling and receiving devices allowing both of them to make and receive calls determined by this invention and perform any desired functions.

The teaching of the present invention allows a skilled person in the art to implement the invention in several different ways without undue burden. In order to use any prior art for implementation of this invention those skilled in the art are referred to any possible related communications standards (such as GSM, UMTS, ITU etc.), solutions and technologies already described in several patent or other related publications. Therefore, it is not the purpose of this patent application to refer to a specific publication or to mention about all features of said technologies, standards or publications but the inventor appreciates the know-how of those skilled in the art to use any possible technology and application for implementation of the present invention. Also any combination of above-mentioned embodiments or any other possible embodiment of the present invention can be used for implementing this invention. All such embodiments or their combinations can be used for different services and different embodiments of the invention. Modifications are possible without departing from the scope of the invention.

It is not the purpose of this patent application to present all possible software codes related to implementation of the present invention, but based on the present invention and its functionalities and any possible embodiment presented or not presented here all rights (including copyright etc.) to the computer or software programs using this invention are reserved to the inventor of this invention.

The present invention can be carried out in different ways which all do not need to be mentioned in this patent application. The invention is described above with detailed information and references to several of its embodiments enabling those skilled in the art to implement this invention. These embodiments are illustrative only of the principles of the invention and are not intended to limit the invention to the specific embodiments described. In view of this disclosure, those skilled in the art will be able to use the principles of this invention in a wide variety of applications to obtain the advantages of this invention, as described above. In addition to the claims appended hereto any other claim and sub-claims can be imagined and driven, by a person skilled in the art, using any passages of description of this invention or any embodiment that can be imagined. Therefore, the limited numbers of claims do not limit the scope of invention or its applications.

1. A method for using in a device (1 or 2 or 5 or 6) like mobile or fixed devices like telephone, mobile phones, wireless modules, computers, servers, a messaging centre, or any other device for communicating control and guidance information, messages and data information between different devices via a telecommunication network (like GSM, UMTS, Fixed networks etc.), the method used as much as required in a calling device or a receiving device or in both of them, the method comprising steps:
in a calling device (like 1) entering, receiving, selecting, or clicking, a control or guidance information or command (like “Switch on sauna”) or a time value (like 2 millisecond) allocated for said information or command;
making a telephone call from said calling device to a receiving device (like 2 or 5 or 6) for carrying out a function (like arrangement of switching on sauna via a relay) or sending or displaying a message, based on counting a predetermined time for a ringing time or length of call in said receiving device or based on predetermined number of said ringing signals detected or observed by said receiving device after said call is hanged up;
in said calling device automatically hanging up said call based on a predetermined ringing time or length of call or based on predetermined number of ringing signals detected or observed in said calling device without needing the user to hang up said call.

2. A method for using in a device (1 or 2 or 5 or 6) like mobile or fixed devices like telephone, mobile phones, wireless modules, computers, servers, a messaging centre, or any other device for communicating control and guidance information, messages and data information between different devices via a telecommunication network (like GSM, UMTS, Fixed networks etc.), the method used as much as required in a calling device or a receiving device or in both of them, the method comprising steps:
typing or selecting or reading a character, or a symbol, or a piece of information, or message (like a, b, or longer messages) in the calling terminal (1);
giving or allocating each part of said message (like letter “a”, “b” and the like) a predetermined time value (like 1 millisecond for letter “a” or a time value for empty spaces between the words and the like);
storing said message in time values, each character or symbol or part of information having a predetermined length of time (like one millisecond for letter “a”);
in said calling terminal, making a telephone call to a receiving terminal (like a mobile phone or any other device, 2);
after answering said call by a receiving device (2), in said calling terminal (1) playing said time values in form of sound/voice (like one millisecond for a sound/voice representing said letter “a”, or symbols and the like) having said time value (length of playing the sound) whereupon when said sound/voice received by said receiving device (2) said receiving device identifies or detects or recognizes or observes the length of said sound/voice and stores said time values (length of each played sound/voice representing a piece of information like character “a”) in a memory;
at this point, or optionally later, hanging up the call or if desired continuing the call (depending on the application);
in said receiving device (2) based on said time value (like 1 millisecond) selecting or producing or retrieving (from a memory) and storing a predetermined character, symbol or piece of information (like character a, b, or the whole messages) and arranging said information (like a message, e-mail and the like) in its original form as the sender has typed/selected or the calling device has read/received and arranged, and whenever required displaying (4) said information to user of receiving terminal.

3. A system for communicating control and guidance information, or any other messages, or data information between different devices (1, 2, 5, 6) like mobile or fixed devices like telephone, mobile phones, wireless modules, computers, servers, a messaging centre, or any other device via a telecommunication network (like GSM, UMTS, Fixed networks and the like) by making a (telephone) call from a calling device (like 1) to a receiving device (like 2 or 5 or 6), the system comprising means (like application programs) arranged for communicating any control or guidance information, or any messages, data, defined by predetermined time values ranging from ringing time or lengths of calls to time values representing a bit of information like letter “A, B” or predetermined number of ringing signals observed in said calling or receiving device, said time values or ringing signals used to automatically carry out any required function (like switching on sauna or displaying a message, or as a message to be displayed) in or via at least one receiving device (like 2 or 5 or 6) after said call is automatically terminated by said calling device according to at least one of said predetermined criteria (ringing time, or ringing signals, or length of call) without needing the user of said calling device to hang up said call.

4. A system as in claim 3, characterized in that said ringing times or length of call or ringing signals are predetermined values for each telephone call allowing said calling device to hang up the call according to a predetermined ringing time or length of call or ringing signal and said receiving device to carry out a function (like arrangement for switching on sauna or to display a message or to perform other functions) based on a predetermined ringing time or length of call or ringing signal.

5. A system as in claim 3, characterized in that said time values representing a piece of information (like letter “A, B, a, b” etc.) are used to define the data entered or selected or read or received in or by or via a calling device in form of a time value for releasing or playing a voice or sound signal according to the length of said time value (like 1 second) over a telephone call for said receiving device wherein said voice or sound signal is translated to form of a original data as selected or entered or read or received in or by said calling device.

6. A system according to any preceding claim, comprising means (like application programs) that are arranged for allowing:
in a calling device entering, receiving, selecting, or clicking, a control or guidance information or command (like “Switch on sauna”) or a time value (like 2 millisecond) allocated for said information or command;
making a telephone call from a calling device to a receiving device;
hanging up said telephone call automatically by said calling device in a predetermined ringing time or length of call or ringing signals without needing the user to hang up said call;
carrying out a function (like arrangement of switching on sauna via a relay) or sending or displaying a message, in or via said receiving device based on counting predetermined time for a ringing time or length of call or based on number of said ringing signals detected or observed by said receiving device.

7. A software product used in or in connection with a device (1 or 2) of a communication system (like GSM, UMTS, fixed network, internet etc.), said device ranged from mobile phone, telephone, computer, to PDA (Personal Digital Assistant) and the like devices, or in memory cards (such as SIM or other attachable/detachable memory means) used in connection with said device (1, 2), said software product comprising means arranged for communication of control and guidance information, or any messages and data information, from a calling device (like 1) to a receiving device (like 2), defined by predetermined time values ranging from ringing time or length of call or a time value representing a bit of information like letter “A” to predetermined number of ringing signals, said time values or ringing signals used for automatically activation of any required function or application (like switching on sauna, or displaying a message, or as a message to be displayed) in or via said receiving device after said call is automatically terminated by said calling device according to said predetermined criteria (ringing time, or ringing signals, or length of call) without needing the user to hang up said call.

8. A memory means (like smart card, SIM, or other memory means attachable/detachable to a communication device like GSM UMTS or the like terminals, 1, 2) for arranging communication of control and guidance information, or any messages and data information between a calling device (like 1) and a receiving device (like 2) via a telecommunication network (like GSM, UMTS, Fixed networks etc.), said memory means comprising means (like application programs) arranged to transmit any control or guidance information, or any messages, or data from said calling device to said receiving device defined by predetermined time values like ringing times or lengths of calls or a time value representing a bit of information like letter “A” or by the number of ringing signals that are predetermined to carry out any required predetermined function (like switching on sauna, or displaying a message) in or via said receiving device after said call is automatically terminated by said calling device according to said predetermined criteria (ringing time, or ringing signals, or length of call) without needing the user to hang up said call.

9. A receiving device (like 2 or 5 or 6) for using in a system as claimed in any preceding claim, comprising at least one of,
means arranged for receiving telephone calls predetermined by ringing times or lengths of calls or ringing signals used to transmit any control or guidance information, or any messages, or data from a calling device (like 1) to a receiving device (like 2 or 5 or 6) after said call is automatically terminated by said calling device according to said predetermined criteria (ringing time, or ringing signals, or length of call) without needing the user to hang up said call;
means arranged for receiving information defined by time values, representing a piece of information (like letter “A, B, a, b” etc.), used to define the data entered, read, received or selected in said calling device, in form of a time values for playing a voice or sound signal according to the length of said time value (like 1 second) over a telephone call for said receiving device wherein or via which said voice or sound signal is translated to restructure or combine the original data as selected or entered in said calling device.

10. A method for authenticating or identifying a user in or via a communication device (1 or 2 or 5 or 6) like mobile or fixed devices like telephone, mobile phones, computers, messaging centres, switching systems, servers or the like, the method used at least in a method, system or device or means of any preceding claim but not limited to any proceeding claim, the method used as much as required in a calling device or a receiving device or in both of them or in a network node/entity, the method comprising the following alternative steps:
authenticating or identifying the calling party based on predetermined ringing time, or ringing signals, or length of call counted or detected or observed in or via a receiving device or network entity when a telephone call is made from a calling device to said receiving device or network entity and when said call is automatically hanged up by said calling device in a predetermined ringing time or length of call or ringing signals without needing the user to hang up said call;
or
performing the steps of claim 2;
authenticating or identifiing the calling party in or via said receiving device based on at least a part of said predetermined time values.

11. A computer program or software product loadable into the memory means of a device ranged from mobile phone, telephone, wireless modules, computers, server, to PDA (Personal Digital Assistant) or any other devices (1, 2) or in memory cards (such as SIM or any other attachable/detachable memory means) used in connection with said devices (1, 2), comprising software code portions for performing, as much as required, the steps of any preceding claim when said product is run on said device.
